(19) United States
(12) Patent Application Publication
(10) Pub. No.: US 2015/0235051 A1
(43) Pub. Date: Aug. 20, 2015

(54) Method And Apparatus For Privacy-Preserving Data Mapping Under A Privacy-Accuracy Trade-Off

(71) Applicant: THOMSON LICENSING, Issy de Moulineaux (FR)

(72) Inventors: Nadia Fawaz, Santa Clara, CA (US); Flavio Du Pin Calmon, Cambridge, MA (US)

(21) Appl. No.: 14/420,476

(22) PCT Filed: Aug. 19, 2013
(86) PCT No.: PCT/US2013/055628

§ 371 Date: Feb. 9, 2015

Related U.S. Application Data
(60) Provisional application No. 61/691,090, filed on Aug. 20, 2012.

(51) Int. Cl. G06F 21/62

(52) U.S. Cl. CPC G06F 21/6245

(57) ABSTRACT

A method for generating a privacy-preserving mapping commences by characterizing an input data set Y with respect to a set of hidden features S. Thereafter, the privacy threat is modeled to create a threat model, which is a minimization of an inference cost gain on the hidden features S. The minimization is then constrained by adding utility constraints to introduce a privacy/accuracy trade-off. The threat model is represented with a metric related to a self-information cost function. Lastly, the metric is optimized to obtain an optimal mapping, in order to provide a mapped output U, which is privacy-preserving.

### CROSS-REFERENCE TO RELATED APPLICATIONS

This application claims priority under 35 U.S.C. 119(e) to U.S. Provisional Patent Application Ser. No. 61/691,090 filed on Aug. 20, 2012, and titled “A FRAMEWORK FOR PRIVACY AGAINST STATISTICAL INFERENCE”. The provisional application is expressly incorporated by reference herein in its entirety for all purposes.

### TECHNICAL FIELD

The present principles relate to statistical inference and privacy-preserving techniques. More particularly, it relates to finding the optimal mapping for user data, which is privacy-preserving under a privacy-accuracy trade-off.

### BACKGROUND

Increasing volumes of user data are being collected over wired and wireless networks, by a large number of companies who mine this data to provide personalized services or targeted advertising to users. FIG. 1 describes a general prior art utility system 100, composed of two main elements: a source 110 and a utility provider 120. The source 110 can be a database storing user data, or at least one user, providing data Y in the clear to a utility provider 120. The utility provider 120 can be, for example, a recommendation system, or any other system that wishes to utilize the user data. However, the utility provider has the ability to infer hidden features S from the input data Y, subjecting the user to a privacy threat.

In particular, present-day recommendation systems can subject a user to privacy threats. Recommenders are often motivated to resell data for a profit, but also to extract information beyond what is intentionally revealed by the user. For example, even records of user preferences typically not perceived as sensitive, such as movie ratings or a person's TV viewing history, can be used to infer a user's political affiliation, gender, etc. The private information that can be inferred from the data processed by a recommendation system is constantly evolving as new data mining and inference methods are developed, for either malicious or benign purposes. In the extreme, records of user preferences can be even used to uniquely identify a user: A. Naranyan and V. Shmatikov strikingly demonstrated this by de-anonymizing the Netflix dataset in their paper “Robust de-anonymization of large sparse datasets”, in IEEE S&P, 2008. As such, even if the recommender is not malicious, an unintentional leakage of such data makes users susceptible to linkage attacks, that is, an attack which uses one database as auxiliary information to compromise the privacy of data in a different database.

As a consequence, privacy is gaining ground as a major topic in the social, legal, and business realms. This trend has spurred recent research in the area of theoretical models for privacy, and their application to the design of privacy-preserving services and techniques. Most privacy-preserving techniques, such as anonymization, k-anonymity, differential privacy, etc., are based on some form of perturbation of the data, either before or after the data are used in some computation. These perturbation techniques provide privacy guarantees at the expense of a loss of accuracy in the computation result, which leads to a trade-off between privacy and accuracy.

In the privacy research community, a prevalent and strong notion of privacy is that of differential privacy. Differential privacy bounds the variation of the distribution of the released output given the input database, when the input database varies slightly, e.g. by a single entry. Intuitively, released data output satisfying differential privacy render the distinction between “neighboring” databases difficult. However, differential privacy neither provides guarantees, nor does it offer any insight on the amount of information leaked when a release of differentially private data occurs. Moreover, user data usually presents correlations. Differential privacy does not factor in correlations in user data, as the distribution of user data is not taken into account in this model.

Several known approaches rely on information-theoretic tools to model privacy-accuracy trade-offs. Indeed, information theory, and more specifically, rate distortion theory appears as a natural framework to analyze the privacy-accuracy trade-off resulting from the distortion of correlated data. However, traditional information theoretic privacy models focus on collective privacy for all the entries in a database, and provide asymptotic guarantees on the average remaining uncertainty per database entry—or equivocation per input variable—after output data release. More precisely, the average equivocation per entry is modeled as the conditional entropy of the input variables given the released data output, normalized by the number of input variables.

On the contrary, the general framework in accordance with the present principles , as introduced herein, provides privacy guarantees in terms of bounds on the inference cost gain that an adversary achieves by observing the released output. The use of a self-information cost yields a non-asymptotic information theoretic framework modeling the privacy risk in terms of information leakage. As a result, a privacy-preserving data mapping is generated based on information leakage and satisfying a privacy-accuracy trade-off.

### SUMMARY

The present principles propose a method and apparatus for generating the optimal mapping for user data, which is privacy-preserving under a privacy-accuracy trade-off against the threat of a passive yet curious service provider or third party with access to the data released by the user.

According to one aspect of the present principles, a method is provided for generating a privacy-preserving mapping including: characterizing an input data set Y with respect to a set of hidden features S; modeling the privacy threat to create a threat model, which is a minimization of an inference cost gain on the hidden features S; constraining said minimization by adding utility constraints to introduce a privacy/accuracy trade-off; representing said threat model with a metric related to a self-information cost function; optimizing the metric to obtain an optimal mapping; and obtaining a mapped output U, which is privacy-preserving.

According to another aspect of the present principles, an apparatus is provided for generating a privacy-preserving mapping including: a processor (402); at least one input/output (404) in signal communication with the processor; and at least one memory (406, 408) in signal communication with the processor, said processor: characterizing an input data set Y with respect to a set of hidden features S; modeling the privacy threat to create a threat model, which is a minimization of an inference cost gain on the hidden features S; constraining said minimization by adding utility constraints to introduce a privacy-accuracy trade-off; representing said threat model with a metric related to a self-information cost function; optimizing said metric to obtain an optimal mapping; and obtaining a mapped output U of said optimal mapping, which is privacy-preserving.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 illustrates the components of a prior art utility system;

FIG. 2 illustrates the components of a privacy-preserving utility system according to an embodiment of the present principles;

FIG. 3 illustrates a high-level flow diagram of a method for generating a privacy-preserving mapping process according to an embodiment of the present principles; and

FIG. 4 illustrates a block diagram of a computing environment within which the method of the present principles may be executed and implemented.

### DETAILED DESCRIPTION

The present principles are directed to the optimal mapping for user data, which is privacy-preserving under a privacy-accuracy trade-off against the threat of a passive yet curious service provider or third party with access to the data. The present principles are set forth as outlined below.

Initially, a general statistical inference framework is proposed to capture the privacy threat or risk incurred by a user that releases information given certain utility constraints. The privacy risk is modeled as an inference cost gain by a passive, but curious, adversary upon observing the information released by the user. In broad terms, this cost gain represents the “amount of knowledge” learned by an adversary after observing the user's output (i.e., information released by the user).

This general statistical inference framework is then applied to the case when the adversary uses the self-information cost function. It is then shown how this naturally leads to a non-asymptotic information-theoretic framework to characterize the information leakage subject to utility constraints. Based on these results two privacy metrics are introduced, namely average information leakage and maximum information leakage in order to further quantify the privacy threat and calculate or determine the privacy preserving mapping to achieve the optimal privacy-utility trade-off.

The average information leakage and maximum information leakage metrics are compared with known techniques of differential privacy to show that the privacy threat determinations made herein by the present principles provide a final more accurate representation of the privacy threat associated with the user's release of information under the respective utility constraints.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

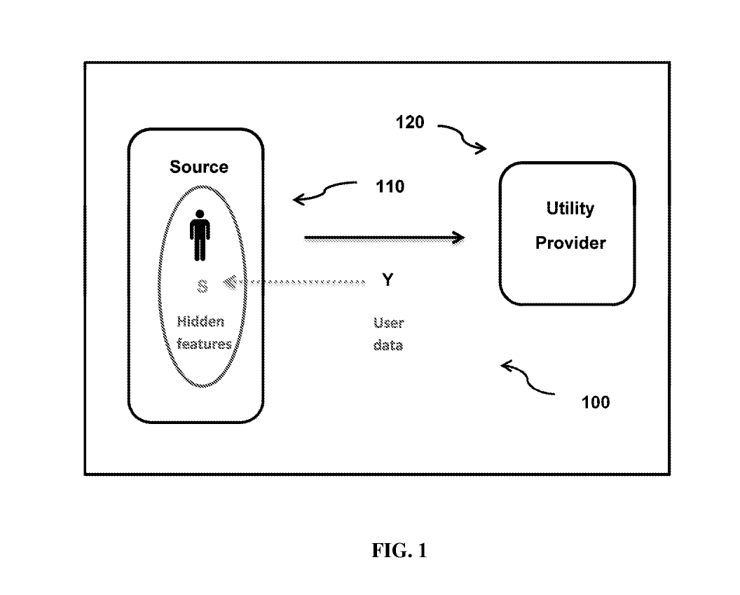

The present principles are described in the context of some user specific data (also referred to as hidden features), S, in FIG. 1, which needs to be kept private, while some measurements or additional data, Y, correlated with the hidden features, are to be released to an analyst (i.e., utility provider, which is a passive but curious adversary). On one hand, the analyst is a legitimate receiver for these measurements and he expects to derive some utility from these measurements. On the other hand, the correlation of these measurements with the user private data gives the analyst the ability to illegitimately infer information on the private user data. The tension between the privacy requirements of the user and the utility expectations of the analyst give rise to the problems of privacy-utility trade-off modeling, and the design of release schemes minimizing the privacy risks incurred by the user, while satisfying the utility constraints of the analyst.

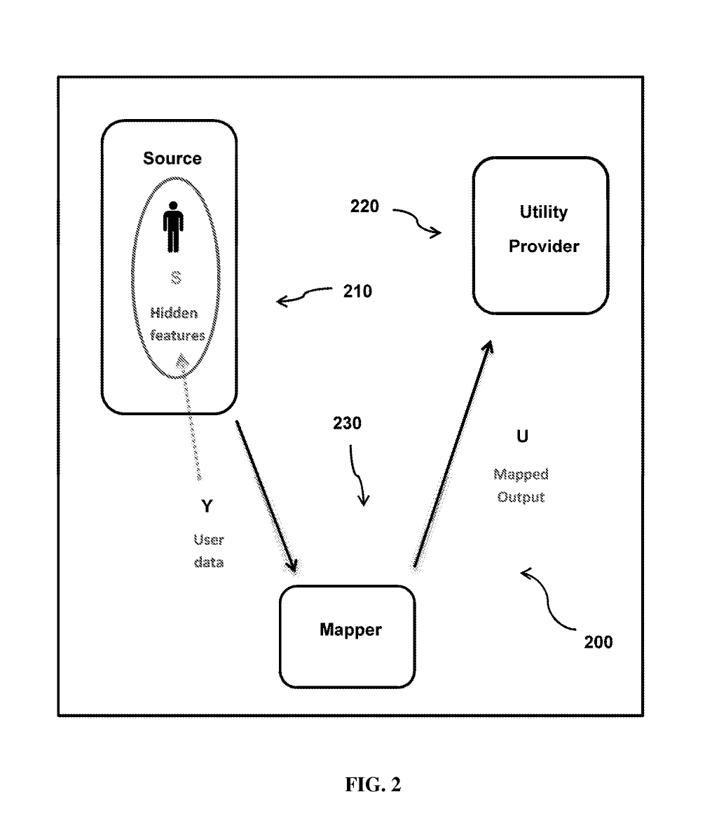

FIG. 2 illustrates a utility system 200 according to an embodiment of the present principles, composed of the following elements: a source 210, a mapper 230 and a utility provider 220. The source 210 can be a database storing user data, or at least one user, providing data Y in a privacy preserving manner. The utility provider 220 can be, for example, a recommendation system, or any other system that wishes to utilize the user data. However, in the prior art system, the utility provider has the ability to infer hidden features S from the input data Y, subjecting the user to a privacy threat. The mapper 230 is an entity that generates a privacy-preserving mapping of the input data Y into an output data U, such that the hidden features S are not inferred by the utility provider under a privacy-accuracy trade-off. The Mapper 230 may be a separate entity, as shown in FIG. 2, or may be included in the source. In a second embodiment, the Mapper 230 sends the mapping to the Source 210, and the Source 210 generates U from the mapping, based on the value of Y.

The following outlines the general privacy setup used according to the present principles and the corresponding threat/risk model generated therefrom.

### General Setup

In accordance with the present example, it is assumed that there are at least two parties that communicate over a noiseless channel, namely Alice and Bob. Alice has access to a set of measurement points, represented by the variable Y∈y, which she wishes to transmit to Bob. At the same time, Alice requires that a set of variables S∈S should remain private, where S is jointly distributed with Y according to the distribution (Y,S)˜p_{Y,S}(y,s), (y,s)∈y×S. Depending on the considered setting, the variable S can be either directly accessible to Alice or inferred from Y. According to the elements of FIG. 2, Alice represents the Source 210 plus Mapper 230 and Bob represents the Utility Provider 220. If no privacy mechanism is in place, Alice simply transmits Y to Bob, as in the prior art case of FIG. 1. If the Mapper 230 is a separate entity from the Source 210, as in FIG. 2, then there is a third party, Mary, representing the Mapper 230.

Bob has a utility requirement for the information sent by Alice. Furthermore, Bob is honest but curious, and will try to learn S from Alice's transmission. Alice's goal is to find and transmit a distorted version of Y, denoted by U∈u, such that U satisfies a target utility constraint for Bob, but “protects” (in a sense made more precise later) the private variable S. Here, it is assumed that Bob is passive, but computationally unbounded, and will try to infer S based on U.

It is considered, without loss of generality, that S→Y→U. This model can capture the case where S is directly accessible by Alice by appropriately adjusting the alphabet y. For example, this can be done by representing S→Y as an injective mapping or allowing S⊂y. In other words, even though the privacy mechanism is designed as a mapping from y to u, it is not limited to an output perturbation, and it encompasses input perturbation settings.

Definition 1: A privacy preserving mapping is a probabilistic mapping g:y→u characterized by a transition probability p_{U|Y}(u|y), y∈y, u∈u.

Since the framework developed here results in formulations that are similar to the ones found in rate-distortion theory, the term “distortion” is used to indicate a measure of utility. Furthermore, the terms “utility” and “accuracy” are used interchangeably throughout this specification.

Definition 2: Let d:y×u→ [symbol] ⁺ be a given distortion metric. We say that a privacy preserving mapping has distortion Δ if [symbol] _{Y,U}[d(Y,U)]≦Δ.

The following assumptions are made:
1. Alice and Bob know the prior distribution of p_{Y,S}(·). This represents the side information that an adversary has.
2. Bob has complete knowledge of the privacy preserving mapping, i.e., probabilistic mapping g and transition probability p_{U|Y}(·) are known.
   This represents the worst-case statistical side information that an adversary can have about the input.

In order to identify and quantify (i.e. capture) the privacy threat/risk, a threat model is generated. In the present example, it is assumed that Bob selects a revised distribution q∈P_{S}, where P_{S} is the set of all probability distributions over S, in order to minimize an expected cost C(S,q). In other words, the adversary chooses q as the solution of the minimization

$${c}_{0}^{*} = {min}_{q ∈ {𝒫}_{S}} {S}_{} [ C ( S , q ) ] \qquad ( 1 )$$

prior to observing U, and

$${c}_{u}^{*} = {min}_{q ∈ {𝒫}_{S}} {S \vert U}_{} [ C ( S , q ) \vert U = u ] \qquad ( 2 )$$

after observing the output U. This restriction on Bob models a very broad class of adversaries that perform statistical inference, capturing how an adversary acts in order to infer a revised belief distribution over the private variables S when observing U. After choosing this distribution, the adversary can perform an estimate of the input distribution (e.g. using a MAP estimator). However, the quality of the inference is inherently tied to the revised distribution q.

The average cost gain by an adversary after observing the output is

ΔC=c₀*− [symbol] _{U}[cᵤ*]. (3)

The maximum cost gain by an adversary is measured in terms of the most informative output (i.e. the output that gives the largest gain in cost), given by

$$Δ {C}^{*} = {c}_{0}^{*} - {min}_{u ∈ 𝒰} {c}_{u}^{*} . \qquad ( 4 )$$

In the next section, a formulation for the privacy-accuracy trade-off is presented, based on this general setting.

### General Formulation for the Privacy-Accuracy Trade-Off

### The Privacy-Accuracy Trade-Off as an Optimization Problem

The goal here is to design privacy preserving mappings that minimize ΔC or ΔC* for a given distortion level Δ, characterizing the fundamental privacy-utility trade-off. More precisely, the focus is to solve optimization problems over p_{U|S}∈P_{U|S} of the form

min ΔC or ΔC* (5)

s, t, [symbol] _{Y,U}[d(Y,U)]≦Δ, (6)

where P_{U|Y} is the set of all conditional probability distributions of U given Y.

Remark 1: In the following, only one distortion (measure of utility) constraint is considered. However, those of skill in the art will appreciate that it is straightforward to generalize the formulation and the subsequent optimization problems to multiple distinct distortion constraints [symbol] _{Y,U}[d₁(Y,U)]≦Δ₁, . . . , [symbol] _{Y,U}[dₙ(Y,U)]≦Δₙ. This can be done by simply adding an additional linear constraint to the convex minimization.

### APPLICATION EXAMPLES

The following is an example of how the proposed model can be cast in terms of privacy preserving queries and hiding features within data sets.

### Privacy-Preserving Queries to a Database

The framework described above can be applied to database privacy problems, such as those considered in differential privacy. In this case, the private variable is defined a vector S=S₁, . . . , Sₙ, where Sⱼ∈S, 1≦j≦n and S₁, . . . , Sₙ are discrete entries of a database that represent, for example, the entries of n users. A (not necessarily deterministic) function f:Sⁿ→y is calculated over the database with output Y such that Y=f(S₁, . . . , Sₙ). The goal of the privacy preserving mapping is to present a query output U such that the individual entries S₁, . . . , Sₙ are “hidden”, i.e. the estimation cost gain of an adversary is minimized according to the previous discussion, while still preserving the utility of the query in terms of the target distortion constraint. An example of this case is the counting query, which will be a recurring example throughout this specification.

### Example 1

### Counting Query

Let S₁, . . . , Sₙ be entries in a database, and define:

$$Y = f ( {S}_{1} , … , {S}_{n} ) = {\sum }_{i = 1}^{n} {A}_{} ( {S}_{i} ) , \\ {A}_{} ( x ) = \{ \begin{matrix}1 & if x has property A , \\ 0 & otherwise .\end{matrix} \qquad ( 7 )$$

In this case there are two possible approaches: (i) output perturbation, where Y is distorted directly to produce U, and (ii) input perturbation, where each individual entry Sᵢ is distorted directly, resulting in a new query output U.

### Hiding Dataset Features

Another important particularization of the proposed framework is the obfuscation of a set of features S by distorting the entries of a data set Y. In this case |S|<<|y|, and S represents a set of features that might be inferred from the data Y, such as age group or salary. The distortion can be defined according to the utility of a given statistical learning algorithm (e.g. a recommendation system) used by Bob.

### Privacy-Accuracy Trade-Off Results

The formulation introduced in the previous section is general and can be applied to different cost functions. In this section, a formulation is made for the case where the adversary uses the self-information cost function, as discussed below.

### The Self-Information Cost Function

The self-information (or log-loss) cost function is given by

C(S,q)=−log q(S). (8)

There are several motivations for using such a cost function. Briefly, the self-information cost function is the only local, proper and smooth cost function for an alphabet of size at least three. Furthermore, since the minimum self-information loss probability assignments are essentially ML estimates, this cost function is consistent with a “rational” adversary. In addition, the average cost-gain when using the self-information cost function can be related to the cost gain when using any other bounded cost function. Finally, as will be seen below, this minimization implies a “closeness” constraint between the prior and a posteriori probability distributions in terms of KL-divergence.

In the next sections it is shown how to apply the above framework in order to define the metrics and solve the optimization problem. In doing this, and as will be evident below, it is explained how the cost minimization problems in equation (5), used with the self-information cost function, can be cast as convex problems and, therefore, can be efficiently solved using interior point methods or widely available convex solvers.

### Average Information Leakage

It is straightforward to show that for the log-loss function c₀*=H(S) and, consequently, cᵤ*=H(S|U=u), and, therefore

$$\begin{matrix}Δ C = I ( S ; U ) = {U}_{} [ D ( {p}_{S \vert U} ∥ {p}_{S} ) ] , & ( 9 ) \\ = H ( S ) - {U}_{} [ H ( S \vert U = u ) ] , & ( 10 )\end{matrix}$$

where D(·∥·) is the KL-divergence. The minimization (5) can then be rewritten according to the following definition.

Definition 3: The average information leakage of a set of features S given a privacy preserving output U is given by I(S;U). A privacy-preserving mapping p_{U|Y}(·) is said to provide the minimum average information leakage for a distortion constraint D if it is the solution of the minimization

$$\begin{matrix}{min}_{{p}_{U \vert Y}} I ( S ; U ) & ( 11 ) \\ s . t . {Y , U}_{} [ d ( Y , U ) ] \leq Δ . & ( 12 )\end{matrix}$$

Observe that finding the mapping p_{U|Y}(u|y) that provides the minimum information leakage is a modified rate-distortion problem. Alternatively, one can rewrite this optimization as

$$\begin{matrix}{min}_{{p}_{U \vert Y}} {U}_{} [ D ( {p}_{S \vert U} ∥ {p}_{S} ) ] & ( 13 ) \\ s . t . {Y , U}_{} [ d ( Y , U ) ] \leq Δ . & ( 14 )\end{matrix}$$

The minimization equation (13) has an interesting and intuitive interpretation. If one considers KL-divergence as a metric for the distance between two distributions, (13) states that the revised distribution after observing U should be as close as possible to the a priori distribution in terms of KL-divergence.

The following theorem shows how the optimization in the previous definition can be expressed as a convex optimization problem. This optimization is solved in terms of the unknowns p_{U|Y}(·|·) and p_{U|S}(·|·), which are coupled together through a linear equality constraint.

Theorem 1: Given p_{S,Y}(·,·), a distortion function d(·,·) and a distortion constraint Δ, the mapping p_{U|Y}(·|·) that minimizes the average information leakage can be found by solving the following convex optimization (assuming the usual simplex constraints on the probability distributions):

$$\begin{matrix}{min}_{{p}_{U \vert Y ,} {p}_{U \vert S}} {\sum }_{u ∈ 𝒰} {\sum }_{s ∈ 𝒮} {p}_{U \vert S} ( u \vert s ) {p}_{S} ( s ) log \frac{{p}_{U \vert S} ( u \vert s )}{{p}_{U} ( u )} & ( 15 ) \\ s . t . {\sum }_{u ∈ 𝒰} {\sum }_{y ∈ 𝒴} {p}_{U \vert Y} ( u \vert y ) {p}_{Y} ( y ) d ( u , y ) \leq Δ , & ( 16 ) \\ {\sum }_{y ∈ 𝒴} {p}_{Y \vert S} ( y \vert s ) {p}_{U \vert Y} ( u \vert y ) = {p}_{U \vert S} ( u \vert s ) ∀ u , s , & ( 17 ) \\ {\sum }_{s ∈ 𝒮} {p}_{U \vert S} ( u \vert s ) {p}_{S} ( s ) = {p}_{U} ( u ) ∀ u . & ( 18 )\end{matrix}$$

Proof. Clearly the previous optimization is the same as equation (11). To prove the convexity of the objective function, since h(x,a)=ax log x is convex for a fixed a≧0 and x≧0 then, the perspective of g₁(x,z,a)=ax log (x/z) is also convex in x and z for z>0, a≧0. Since the objective function (15) can be written as

$${\sum }_{u ∈ 𝒰} {\sum }_{s ∈ 𝒮} g ( {p}_{U \vert S} ( u \vert s ) , {p}_{U} ( u ) , {p}_{S} ( s ) ) ,$$

it follows that the optimization is convex. In addition, since p(u)→0 [symbol] p(u|s)→0 ∀u, the minimization is well defined over the probability simplex.

Remark 2: The previous optimization can also be solved using a dual minimization procedure analogous to the Arimoto-Blahut algorithm by starting at a fixed marginal probability p_{U}(u), solving a convex minimization at each step (with an added linear constraint compared to the original algorithm) and updating the marginal distribution. However, the above formulation allows the use of efficient algorithms for solving convex problems, such as interior-point methods. In fact, the previous minimization can be simplified to formulate the traditional rate-distortion problem as a single convex minimization, not requiring the use of the Arimoto-Blahut algorithm.

Remark 3: The formulation in Theorem 1 can be easily extended to the case when U is determined directly from S, i.e. when Alice has access to S and the privacy preserving mapping is given by p_{U|S}(·|·) directly. For this, constraint (17) should be substituted by

$${\sum }_{y ∈ 𝒴} {p}_{Y \vert S} ( y \vert s ) {p}_{U \vert Y , S} ( u \vert y , s ) = {p}_{U \vert S} ( u \vert s ) ∀ u , s , \qquad ( 19 )$$

and the following linear constraint added

$${\sum }_{s ∈ 𝒮} {p}_{S \vert Y} ( s \vert y ) {p}_{U \vert Y , S} ( u \vert y , s ) = {p}_{U \vert Y} ( u \vert y ) ∀ u , y , \qquad ( 20 )$$

with the minimization being performed over the variables p_{U|Y,S}(u|y,s),p_{U|Y}(u|y) and p_{U|S}(u|s), with the usual simplex constraints on the probabilities.

In the following, the previous result is particularized for the case where Y is a deterministic function of S.

Corollary 1: If Y is a deterministic function of S and S→Y→U then the minimization in (11) can be simplified to a rate-distortion problem:

$$\begin{matrix}{min}_{{p}_{U \vert Y}} I ( Y ; U ) & ( 21 ) \\ s . t . {Y , U}_{} [ d ( Y , U ) ] \leq D . & ( 22 )\end{matrix}$$

Furthermore, by restricting U=Y+Z and d(Y,U)=d(Y−U), the optimization reduces to

$$\begin{matrix}{max}_{{p}_{Z}} H ( Z ) & ( 23 ) \\ s . t . {𝔼}_{Z} [ d ( Z ) ] \leq Δ . & ( 24 )\end{matrix}$$

Proof. Since Y s a deterministic function of S and S→Y→U, then

I(S;U)=I(S,Y;U)−I(Y;U|S) (25)

=I(Y;U)+I(S;U|Y)−I(Y;U|S) (26)

=I(Y;U), (27)

where (27) follows from the fact that Y is a deterministic function of S(I(Y;U|S)=0) and 5→Y→U (I(S;U|Y)=0). For the additive noise case, the result follows by observing that H(Y|U)=H(Z).

### Maximum Information Leakage

The minimum over all possible maximum cost gains of an adversary that uses a log-loss function in equation (4) is given by

$${C}^{*} = {max}_{u ∈ 𝒰} H ( S ) - H ( S \vert U = u ) .$$

The previous expression motivates the definition of maximum information leakage, presented below.

Definition 4: The maximum information leakage of a set of features S is defined as the maximum cost gain, given in terms of the log-loss function that an adversary obtains by observing a single output, and is given by max_{u∈U} H(S)−H(S|U=u). A privacy-preserving mapping p_{U|Y}(·) is said to achieve the minmax information leakage for a distortion constraint Δ if it is a solution of the minimization

$$\begin{matrix}{min}_{{p}_{U \vert Y}} {max}_{u ∈ 𝒰} H ( S ) - H ( S \vert U = u ) & ( 28 ) \\ s . t . 𝔼 [ d ( U , Y ) ] \leq Δ & ( 29 )\end{matrix}$$

The following theorem demonstrates how the mapping that achieves the minmax information leakage can be determined as the solution of a related convex minimization that finds the minimum distortion given a constraint on the maximum information leakage.

Theorem 2: Given p_{S,Y}(·,·), a distortion function d(·,·) and a constraint ε on the maximum information leakage, the minimum achievable distortion and the mapping that achieves the minmax information leakage can be found by solving the following convex optimization (assuming the implicit simplex constraints on the probability distributions):

$$\begin{matrix}{min}_{{p}_{U \vert Y} , {p}_{U \vert S}} {\sum }_{u ∈ 𝒰} {\sum }_{s ∈ 𝒮} {p}_{U \vert Y} ( u \vert y ) {p}_{Y} ( y ) d ( u , y ) & ( 30 ) \\ s . t . {\sum }_{y ∈ 𝒴} {p}_{Y \vert S} ( y \vert s ) {p}_{U \vert Y} ( u \vert y ) = {p}_{U \vert S} ( u \vert s ) ∀ u , s , & ( 31 ) \\ {\sum }_{s ∈ 𝒮} {p}_{U \vert S} ( u \vert s ) {p}_{S} ( s ) = {p}_{U} ( u ) ∀ u , & ( 32 ) \\ δ {p}_{U} ( u ) + {\sum }_{s ∈ 𝒮} {p}_{U , S} ( u , s ) log \frac{{p}_{U , S} ( u , s )}{{p}_{U} ( u )} \leq 0 ∀ u , & ( 33 )\end{matrix}$$

where δ=H(S)−ε. Therefore, for a given value of Δ, the optimization problem in (28) can be efficiently solved with arbitrarily large precision by performing a line-search over ε∈[0,H(S)] and solving the previous convex minimization at each step of the search.

Proof. The convex minimization in (28) can be reformulated to return the minimum distortion for a given constraint ε on the minmax information leakage as

$$\begin{matrix}{min}_{{p}_{U \vert Y}} 𝔼 [ d ( U , Y ) ] & ( 34 ) \\ s . t . H ( S \vert U = u ) \geq δ . & ( 35 )\end{matrix}$$

It is straightforward to verify that constraint (33) can be written as (35). Following the same steps as the proof of Theorem 1 and noting that the function g₂(x,z,a)=ax log (ax/z) is convex for a,x≧0, z>0, it follows that (35) and, consequently, (32), is a convex constraint. Finally, since the optimal distortion value in the previous minimization is a decreasing function of ε, it follows that the solution of (28) can be found through a line-search in ε.

Remark 4: Analogously to the average information leakage case, the convex minimization presented in Theorem (2) can be extended to the setting where the privacy preserving mapping is given by p_{U|S}(·|·) directly. This can be done by substituting (32) by (19) and adding the linear constraint (20).

Even though the convex minimization presented in Theorem 2 holds in general, it does not provide much insight on the structure of the privacy mapping that minimizes the maximum information leakage for a given distortion constraint. In order to shed light on the nature of the optimal solution, the following result is presented, for the particular case when Y is a deterministic function of S and S→Y→U.

Corollary 2: For Y=f(S), where f:S→y is a deterministic function, S→Y→U and a fixed prior p_{Y,S}(·,·), the privacy preserving mapping that minimizes the maximum information leakage is given by

$${p}_{U \vert Y}^{*} = arg {min}_{{p}_{U \vert Y}} {max}_{u ∈ 𝒰} D ( {p}_{Y \vert U} \vert \vert ζ ) \\ s . t . 𝔼 [ d ( U , Y ) ] \leq Δ , \\ where \\ ζ ( y ) = \frac{{2}^{H ( X \vert Y = y )}}{{\sum }_{{u}^{′} ∈ y} {2}^{H ( X \vert Y = {y}^{′} )}} . \qquad ( 36 )$$

Proof: Under the assumptions of the corollary, for a given u∈u (and assuming that the logarithms are in base 2)

$$\begin{matrix}H ( S \vert U = u ) = - {\sum }_{s ∈ 𝒮} {p}_{S \vert U} ( s \vert u ) log {p}_{S \vert U} ( s \vert u ) \\ = - {\sum }_{s ∈ 𝒮} ( {\sum }_{y ∈ 𝒴} {p}_{S \vert Y} ( s \vert y ) {p}_{Y \vert U} ( y \vert u ) ) \times \\ ( log {\sum }_{u ∈ 𝒴} {p}_{S \vert Y} ( s \vert y ) {p}_{Y \vert U} ( y \vert u ) ) \\ = - {\sum }_{s ∈ 𝒮} {p}_{S \vert Y} ( s \vert f ( s ) ) {p}_{Y \vert U} ( f ( s ) \vert u ) \times \\ log {p}_{S \vert Y} ( s \vert f ( s ) ) {p}_{Y \vert U} ( f ( s ) \vert u ) \\ = - {\sum }_{s ∈ 𝒮 , y ∈ 𝒴} {p}_{S \vert Y} ( s \vert y ) {p}_{Y \vert U} ( y \vert u ) log {p}_{S \vert Y} ( s \vert y ) {p}_{Y \vert U} ( y \vert u ) \\ = H ( Y \vert U = u ) + {\sum }_{y ∈ 𝒴} {p}_{Y \vert U} ( y \vert u ) H ( S \vert Y = y ) \\ = {\sum }_{y ∈ 𝒴} {p}_{Y \vert U} ( y \vert u ) log \frac{{2}^{H ( X \vert Y = y )}}{{p}_{Y \vert U} ( y \vert u )} ( 38 ) \\ = - D ( {p}_{Y \vert U} \vert \vert ζ ) + log ( {\sum }_{y ∈ 𝒴} {2}^{H ( X \vert Y = y )} ) , ( 39 )\end{matrix} \qquad ( 37 )$$

The result follows directly by substituting (39) in (28).

For Y a deterministic function of S, the optimal privacy preserving mechanism is the one that approximates (in terms of KL-divergence) the posterior distribution of Y given U to ζ(·). The distribution ζ(·) captures the inherent uncertainty that exists in the function f for different outputs y∈y. The purpose of the privacy preserving mapping is then to augment this uncertainty, while still satisfying the distortion constraint. In particular, the larger the uncertainty H(S|Y=y), the larger the probability of p_{Y|U}(y|u) for all u. Consequently, the optimal privacy mapping (exponentially) reinforces the posterior probability of the values of y for which there is a large uncertainty regarding the features S. This fact is illustrated in the next example, where the counting query presented in Example 1 is revisited.

### Example 2

### Counting Query Continued

Assume that each database input Sᵢ, 1≦i≦n satisfies Pr( [symbol] (Sᵢ)=1)=p and are independent and identically distributed. Then Y is a binomial random variable with parameter (n,p). It follows that

$$H ( S \vert Y = y ) = log ( \begin{matrix}n \\ y\end{matrix} ) .$$

Consequently, the optimal privacy preserving mapping will be the one that results in a posterior probability p_{Y|U}(y|u) that is proportional to the size of the pre-image of y, i.e., p_{Y|U}(y|u)∝|f⁻¹(y)|.

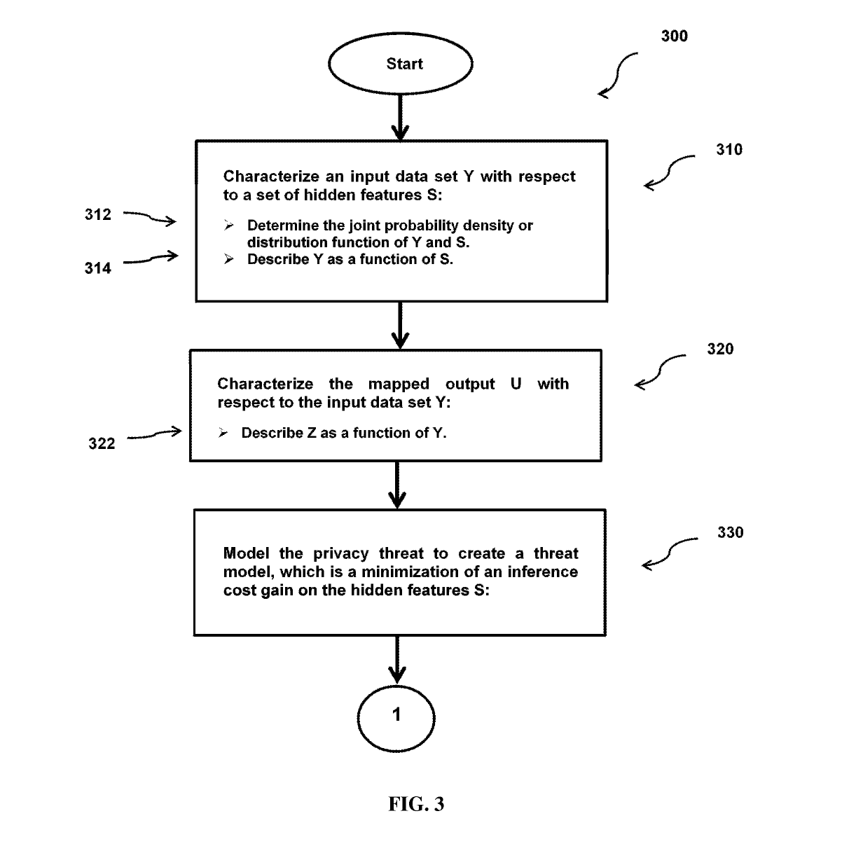

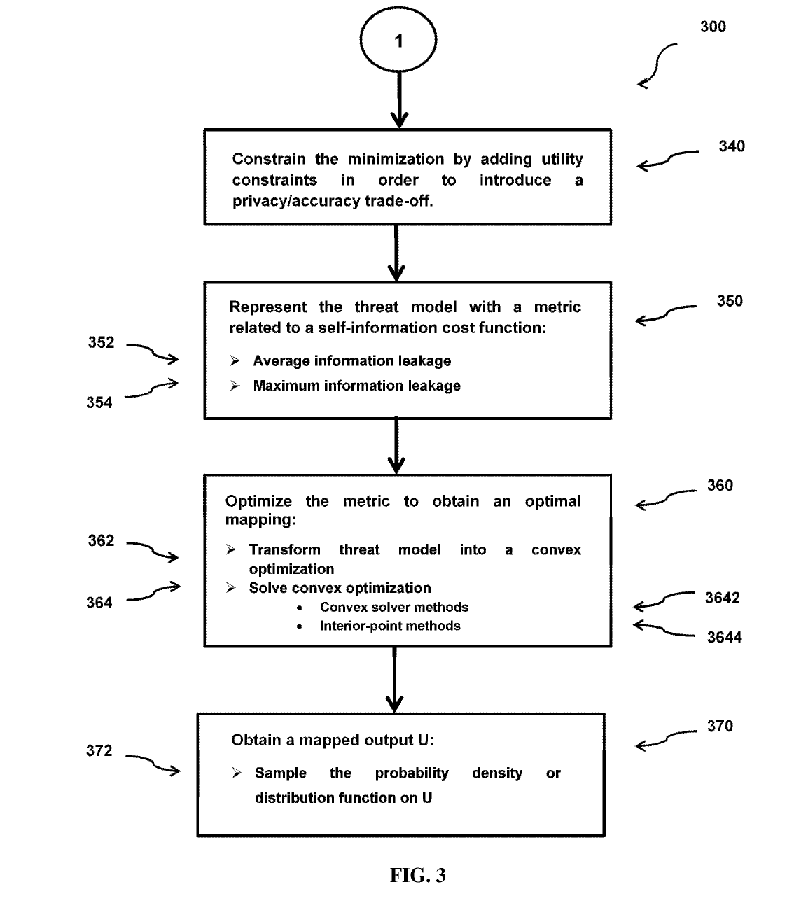

Referring now to FIG. 3, there is shown a high level flow diagram of the method 300 for generating a privacy-preserving mapping according to an implementation of the present principles. This method is implemented by the Mapper 230 in FIG. 2. First, an input data set Y is characterized with respect to a set of hidden features S 310. This includes determining the joint probability density function or probability distribution function of Y and the hidden S features 312. For example, in a large database, statistical inference methods can perform this characterization to jointly model the two variables Y and S. It may also include describing Y as a deterministic or non-deterministic function of S 314. It is also possible to predetermine a relationship between the mapped output U and the input data Y 320. This includes the case where U is a function of Y, including a deterministic or non-deterministic function of Y 322. Next, the privacy threat is modeled as a minimization of an inference cost gain on the hidden features S upon observing the released data U 330. The minimization is constrained by the addition of utility constraints in order to introduce a privacy/accuracy trade-off 340. The threat model can then be represented with a metric related to a self-information cost function 350. This includes two possible metrics: the average information leakage 352 and the maximum information leakage 354. By optimizing the metric subject to a distortion constraint, an optimal mapping is obtained 360. This may include transforming the threat model into a convex optimization 362 and solving the convex optimization 364. The step of solving the convex optimization can be performed with interior-point methods 3644 or convex solver methods 3642. The output of the convex optimization is the privacy preserving mapping, which is a probability density or distribution function. The final step consists in obtaining a mapped output U. This includes possibly sampling the probability density function or probability distribution function on U. For example, if U is a function of Y plus noise, the noise will be sampled according to a model that satisfies its characterization. If the noise is pseudo-random, a deterministic function is used to generate it.

In an implementation of the method of the present principles, the steps of modeling the privacy threat (330) and representing the threat model with a metric (350) may be processed in advance (i.e., pre-processed or pre-computed), such that the Mapper 230 just implements the results of these steps. In addition, the step of constraining the minimization (340) may also be pre-processed and parameterized by a distortion D (representing the utility constraint). The steps of characterizing the input (310) and output (320) may also be pre-processed for particular applications. For example, a medical database which is to be analyzed for a study on diabetes may be pre-processed to characterize the input data of interest, Y, the private data, S, and their statistical relationship in the database. A characterization of the output U as a non-deterministic function of Y may be made in advance (e.g., U is a function of Y plus noise). Furthermore, the step of optimizing may also be pre-processed for certain implementations with a closed form solution. In those cases, the solution may be parameterized as a function of Y. Therefore, for some implementations, the Mapper 230 in FIG. 2 may be simplified to the step of obtaining the mapped output U as a function of the input Y, based on the solution of the previously pre-processed steps.

### Comparison of Privacy Metrics

One can compare the average information leakage and maximum information leakage with differential privacy and information privacy, the latter being a new metric hereby introduced. First, the definition of differential privacy is recalled, presenting it in terms of the threat model previously discussed and assuming that the set of features S is a vector given by S=(S₁, . . . , Sₙ), where Sᵢ∈S.

Definition 5: A privacy preserving mapping p_{U|S}(·|·) provides ε-differential privacy if for all inputs s₁ and s₂ differing in at most one entry and all B⊂u,

Pr(U∈B|S=s₁)≦exp(ε)×Pr(U∈B|S=s₂). (40)

An alternative (and much stronger) definition of privacy is given below. This definition is unwieldy, but explicitly captures the ultimate goal in privacy: the posterior and prior probabilities of the features S do not change significantly given the output.

Definition 6: A privacy preserving mapping p_{U|S}(·|·) provides ε-information privacy if for all s⊂Sⁿ:

$$exp ( - ε ) \leq \frac{{p}_{S \vert U} ( s \vert u )}{{p}_{S} ( s )} \leq exp ( ε ) ∀ u ∈ 𝒰 : {p}_{U} ( u ) > 0. \qquad ( 41 )$$

Hence, ε-information privacy implies directly 2ε-differential privacy and maximum information leakage of at most ε/ln 2 bits, as shown below.

Theorem 3: If a privacy preserving mapping p_{U|S}(·|·) is ε-information private for some input distribution such that supp(p_{U})=u, then it is at least 2ε-differentially private and leaks at most ε/ln 2 bits on average.

Proof. Note that for a given B⊂u

$$\begin{matrix}\frac{Pr ( U ∈ B \vert S = {s}_{1} )}{Pr ( U ∈ B \vert S = {s}_{2} )} = \frac{Pr ( S = {s}_{1} \vert U ∈ B ) Pr ( S = {s}_{2} )}{Pr ( S = {s}_{2} \vert U ∈ B ) Pr ( S = {s}_{1} )} . \\ \leq exp ( 2 ε ) . ( 43 )\end{matrix} \qquad ( 42 )$$

where the last step follows from (40). Clearly if s₁ and s₂ are neighboring vectors (i.e. differ by only one entry), then 2ε-differential privacy is satisfied. Furthermore

$$\begin{matrix}H ( S ) - H ( S \vert U = u ) = {\sum }_{s ∈ {𝒮}^{n}} {p}_{S \vert U} ( s \vert u ) {p}_{U} ( u ) log \frac{{p}_{S \vert U} ( s \vert u )}{{p}_{S} ( s )} \\ \leq {\sum }_{s ∈ {𝒮}^{n} , u ∈ 𝒰} {p}_{S \vert U} ( s \vert u ) {p}_{U} ( u ) \frac{ε}{ln 2} . ( 45 ) \\ = ε ( 46 )\end{matrix} \qquad ( 44 )$$

The following theorem shows that differential privacy does not guarantee privacy in terms of average information leakage in general and, consequently in terms of maximum information leakage and information privacy. More specifically, guaranteeing that a mechanism is ε-differentially private does not provide any guarantee on the information leakage.

Theorem 4. For every ε>0 and δ≧0, there exists an n∈ [symbol] ₊, sets Sⁿ and u, a prior p_{S}(·) over Sⁿ and a privacy mapping p_{U|S}(·|·) that is ε-differentially private but leaks at least δ bits on average.

Proof. The statement is proved by explicitly constructing an example that is ε-differentially private, but an arbitrarily large amount of information can leak on average from the system. For this, the counting query discussed in examples 1 and 2 is revisited, with the sets S and y being defined accordingly, and letting u=y. Independence of the inputs is not assumed.

For the counting query and for any given prior, adding Laplacian noise to the output provides ε-differential privacy. More precisely, for the output of the query given in (7), denoted as Y˜p_{Y}(y), 0≦y≦n, the mapping

U=Y+N, N˜Lap(1/ε), (47)

where the probability density function (pdf) of the additive noise N given by

$${p}_{N} ( r ; ε ) = \frac{ε}{2} exp ( - \vert r \vert ε ) , \qquad ( 48 )$$

is ε-differentially private. Now assume that ε is given, and denote S=(X₁, . . . , Xₙ). Set k and n such that n mod k=0, and let p_{S}(·) be such that

$${p}_{Y} ( y ) = \{ \begin{matrix}\frac{1}{1 + n / k} & if y mod k = 0 , \\ 0 & otherwise\end{matrix} . \qquad ( 49 )$$

With the goal of lower-bounding the information leakage, assume that the adversary (i.e., Bob), after observing U, maps it to the nearest value of y such that p_{Y}(y)>0, i.e. does a maximum a posteriori estimation of Y. The probability that Bob makes a correct estimation (and neglecting edge effects), denoted by a_{k,n}(ε), is given by:

$${α}_{k , n} ( ε ) = {\int }_{\frac{- k}{2}}^{\frac{k}{2}} \frac{ε}{2} exp ( - \vert x \vert ε ) d x = 1 - exp ( - \frac{k ε}{2} ) . \qquad ( 50 )$$

Let E be a binary random variable that indicates the event that Bobs makes a wrong estimation of Y given U. Then

$$\begin{matrix}I ( Y ; U ) \geq I ( E , Y ; U ) - 1 \\ \geq I ( Y ; U \vert E ) - 1 \\ = ( 1 - {e}^{- \frac{k ε}{2}} ) log ( 1 + \frac{n}{k} ) - 1 ,\end{matrix}$$

which can be made arbitrarily larger than δ by appropriately choosing the values of n and k. Since Y is a deterministic function of S, I(Y;U)=I(S;U), as shown in the proof of Corollary 1, and the result follows.

The counterexample used in the proof of the previous theorem can be extended to allow the adversary to recover exactly the inputs generated from the output U. This can be done by assuming that the inputs are ordered and correlated in such a way that Y=y if and only if S₁=1, . . . , S_{y}=1. In this case, for n and k sufficiently large, the adversary can exploit the input correlation to correctly learn the values of S₁, . . . , Sₙ with arbitrarily high probability.

Differential privacy does not necessarily guarantee low leakage of information—in fact, an arbitrarily large amount of information can be leaking from a differentially private system, as shown in Theorem 4. This is a serious issue when using solely the differential privacy definition as a privacy metric. In addition, it follows as a simple extension of know methods that I(S;U)≦0(εn), corroborating that differential privacy does not bound above the average information leakage when n is sufficiently large.

Nevertheless, differential privacy does have some operational advantage since it does not require any prior information. However, by neglecting the prior and requiring differential privacy, the resulting mapping might not be de facto private, being suboptimal under the information leakage measure. In the present principles, the presented formulations can be made prior independent by minimizing the worst-case over a set of possible priors (P_{S,Y}, S and Y) of the (average or maximum) information leakage. This problem is closely related to universal coding.

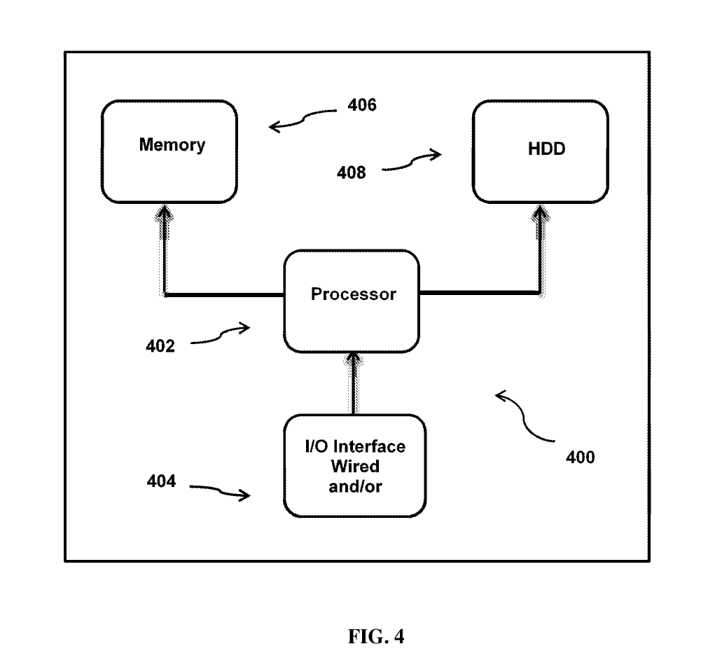

FIG. 4 shows a block diagram of a minimum computing environment 400 within which the present principles can be implemented. The computing environment 400 includes a processor 402, and at least one (and preferably more than one) I/O interface 404. The I/O interface can be wired or wireless and, in the wireless implementation is pre-configured with the appropriate wireless communication protocols to allow the computing environment 400 to operate on a global network (e.g., internet) and communicate with other computers or servers (e.g., cloud based computing or storage servers) so as to enable the present principles to be provided, for example, as a Software as a Service (SAAS) feature remotely provided to end users. One or more memories 406 and/or storage devices (HDD) 408 are also provided within the computing environment 400.

In conclusion, the above presents a general statistical inference framework to capture and cure the privacy threat incurred by a user that releases data to a passive but curious adversary given utility constraints. It has been shown how, under certain assumptions, this framework naturally leads to an information-theoretic approach to privacy. The design problem of finding privacy-preserving mappings for minimizing the information leakage from a user's data with utility constraints was formulated as a convex minimization. This approach can lead to practical and deployable privacy-preserving mechanisms. Finally, this approach was compared with differential privacy, and showed that the differential privacy requirement does not necessarily constrain the information leakage from a data set.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method of generating a privacy-preserving mapping of an input data set which is subject to a privacy threat, said method performed by a processor and comprising:
determining a relationship between said input data set Y and a set of hidden features S, wherein said relationship is not a deterministic function;
minimizing a metric on the hidden features S subject to utility constraints in order to obtain an optimal mapping, wherein said metric describes the privacy threat and is based on a self-information cost function and said utility constraints are based on a distortion between the input data set and an output of said privacy-preserving mapping; and
obtaining an output U of said optimal mapping, wherein said output is privacy-preserving on the hidden features.

2. The method of claim 1, wherein the step of minimizing comprises:
transforming said metric minimization into a convex optimization; and
solving said convex optimization.

3. The method of claim 1, wherein said metric is one of an average information leakage and a maximum information leakage of said set of hidden features S given said privacy-preserving mapping.

4. The method of claim 2, wherein the step of solving said convex optimization comprises:
using one of convex solver methods and interior-point methods.

5. The method of claim 1, wherein the step of determining comprises:
determining one of a joint probability density and a distribution function of the input data set Y and the hidden features S.

6. The method of claim 1, wherein the output U is a function of Y.

7. The method of claim 6, wherein the optimal mapping is of the type: U=Y+Z, wherein Z is an additive noise variable and said utility constraint is a function of Z.

8. The method of claim 1, wherein the privacy-preserving mapping is used for privacy-preserving queries to a database, wherein S represents discrete entries to a database of n users, Y is a non-deterministic function of S, and U is a query output, such that the individual entries S are hidden to an adversary with access to U.

9. (canceled)

10. (canceled)

11. The method of claim 1, wherein the step of obtaining comprises:
sampling one of a probability density and a distribution function on U.

12. The method of claim 7, wherein the noise is one of Laplacian, Gaussian and pseudo-random noise.

13. The method of claim 1, wherein the step of minimizing is pre-processed.

14. The method of claim 1, wherein the step of determining is pre-processed.

15. An apparatus for generating a privacy-preserving mapping of an input data set which is subject to a privacy threat, said apparatus comprising:
a processor, for receiving at least one input/output; and
at least one memory in signal communication with said processor, said processor being configured to:
determine a relationship between said input data set Y and a set of hidden features S, wherein said relationship is not a deterministic function;
minimize a metric on the hidden features S subject to utility constraints in order to obtain an optimal mapping, wherein said metric describes the privacy threat and is based on a self-information cost function and said utility constraints are based on a distortion between the input data set and an output of said privacy-preserving mapping; and
obtain an output U of said optimal mapping, wherein said output is privacy-preserving on the hidden features.

16. The apparatus of claim 15, wherein said processor is configured to minimize by being configured to:
transform said metric minimization into a convex optimization; and
solve said convex optimization.

17. The apparatus of claim 15, wherein said metric is one of an average information leakage and a maximum information leakage of said set of hidden features S given said privacy-preserving mapping.

18. The apparatus of claim 15, wherein said processor is configured to solve said convex optimization by being configured to:
use one of convex solver methods and interior-point methods.

19. The apparatus of claim 15 wherein said processor is configured to determine a relationship by being configured to:
determine the joint probability density or distribution function of the input data set Y and the hidden features S.

20. The apparatus of claim 15, wherein the output U is a function of Y.

21. The apparatus of claim 20, wherein the optimal mapping performed by said processor is of the type: U=Y+Z, wherein Z is an additive noise variable and said utility constraint (distortion) is a function of Z.

22. The apparatus of claim 15, wherein the privacy-preserving mapping performed by said processor is used for privacy-preserving queries to a database, wherein S represents discrete entries to a database of n users, Y is a non-deterministic function of S, and U is a query output, such that the individual entries S are hidden to an adversary with access to U.

23. (canceled)

24. (canceled)

25. The apparatus of claim 15, wherein said processor is configured to obtain a mapped output U by being configured to:
sample a probability density or distribution function on U.

26. The apparatus of claim 21, wherein the noise is one of Laplacian, Gaussian and pseudo-random noise.

27. The apparatus of claim 15, wherein the step of minimizing is pre-processed.

28. The apparatus of claim 27, wherein the step of determining is pre-processed.
